(19) United States
(12) Patent Application Publication
(10) Pub. No.: US 2025/0380073 A1
(43) Pub. Date: Dec. 11, 2025

(54) LOUDSPEAKER ASSEMBLY FOR VEHICLE

(71) Applicant: HAYASHI TELEMPU CORPORATION, AICHI (JP)

(72) Inventors: Teppei SUGIURA, Nagoya (JP); Yugo SAITO, Nagoya (JP); Tetsuharu KOJIMA, Nagoya (JP)

(73) Assignee: HAYASHI TELEMPU CORPORATION, AICHI (JP)

(21) Appl. No.: 19/233,672

(22) Filed: Jun. 10, 2025

(30) Foreign Application Priority Data
Jun. 11, 2024 (JP) 2024-094473

(51) Int. Cl. H04R 1/02; B60Q 3/217; B60Q 3/62; F21V 8/00

(52) U.S. Cl. CPC H04R 1/028; B60Q 3/62; G02B 6/0028; H04R 1/023; B60Q 3/217; H04R 2499/13

(57) ABSTRACT

Provided is a loudspeaker assembly for a vehicle with an enhanced design quality and enhanced acoustic performance. The loudspeaker assembly for a vehicle includes: a loudspeaker unit that includes a sound output element; a light guide component disposed around the sound output element; and a loudspeaker grille disposed so as to be situated on the side of a cabin interior of the vehicle relative to the loudspeaker unit and the light guide component. At least a part of the loudspeaker grille is transparent to light. The light guide component is configured to be illuminated in such a way to create an annular luminous zone on a cabin interior side of the loudspeaker grille.

### CROSS REFERENCE TO THE RELATED APPLICATION

This application is based on and claims Convention priority to Japanese patent application No. 2024-094473, filed Jun. 11, 2024, the entire of which is herein incorporated by reference as a part of this application.

### BACKGROUND OF THE INVENTION

### Field of the Invention

The present invention relates to a loudspeaker assembly for a vehicle.

### Description of Related Art

When it comes to a loudspeaker assembly to be installed in a vehicle for a sound system in the vehicle, it is desired to achieve an excellent design quality and excellent acoustic performance in response to the increased level of needs on the passenger environment inside the cabin.

For loudspeakers of a vehicle sound system, an arrangement is known in which a vehicle loudspeaker assembly is disposed in an interior material of a vehicle, e.g., a door trim that is mounted on the cabin interior side of a door of the vehicle (JP Laid-open Patent Publication No. 2017-019312). With respect to the design of a loudspeaker that utilizes light, it is known for a loudspeaker assembly to have a vehicle loudspeaker grille that is produced from a partially transparent material to allow light from a light illuminator under the loudspeaker grille to be transmitted therethrough (JP Laid-open Patent Publication No. 2002-096691). For a light illuminator, a ring-shaped light illuminator is known that includes a combination of a light guide component formed from light transmissive material and an LED or some other similar element (JP Laid-open Patent Publication No. 2006-179379).

### SUMMARY OF THE INVENTION

In order to ensure both the design quality and the acoustic performance of such a vehicle loudspeaker assembly having a loudspeaker grille with an illuminating capability, appropriate selection of light illuminator geometry, illumination pattern, etc., as well as the position relationship among the light illuminator, the loudspeaker grille, and the sound output element of the loudspeaker is necessary.

An object of the present invention is to provide an in-vehicle loudspeaker assembly with an excellent design quality and excellent acoustic performance.

A loudspeaker assembly for a vehicle according to the present invention includes: a loudspeaker unit that includes a sound output element; a light guide component disposed around the sound output element; and a loudspeaker grille disposed so as to be situated on the side of a cabin interior of the vehicle relative to the loudspeaker unit and the light guide component. At least a part of the loudspeaker grille is transparent to light. The light guide component is configured to be illuminated in such a way to create an annular luminous zone on a cabin interior side of the loudspeaker grille.

According to this configuration, lighting with an excellent design quality can be created in a vehicle loudspeaker.

In the present invention, the loudspeaker grille may have a transmissive section that is transparent to light emitted from the light guide component and a non-transmissive section that is opaque to light.

According to this configuration, the positions of the transmissive section and the non-transmissive section of the loudspeaker grille can be combined in any desired manner so as to define the shape of light emitted from the light guide component and transmitted through the loudspeaker grille.

In the present invention, the light guide component may comprise an annular geometrical element having an outer diameter surface, an inner diameter surface, an interior side surface to be on the side of the cabin interior, and an exterior side surface to be on the side of a cabin exterior of the vehicle, the annular geometrical element may further have a skewed surface which is at an inclination to the axial direction of the annular geometrical element and via which the interior side surface and the inner diameter surface are joined, and the annular geometrical element may have a radial cross section with a pentagonal shape having three substantially right angles.

According to this configuration, the effect from undesired refraction of light at a relevant corner between the surfaces of the light guide component can be lessened, thereby resulting in an enhanced design quality of the luminous pattern from the light guide component as observed from the cabin interior.

In the present invention, the loudspeaker grille may comprise a frustoconical tubular element with a diameter that increases towards the cabin interior, the frustoconical tubular element may be disposed coaxial with the annular geometrical element of the light guide component, and the frustoconical tubular element may have inner and outer peripheral faces with respective inclination angles that are substantially identical to the inclination angle of the skewed surface of the light guide component.

According to this configuration, even though it is through the loudspeaker grille that the luminous pattern from the light guide component is observed, the annular luminous zone can still be provided with little or no loss of its design quality.

In the present invention, the smallest distance from the external contour line of the sound output element to the external contour line of the outer periphery of the loudspeaker grille may be at least 9.5 mm when the sound output element is frontally viewed in a plan view.

According to this configuration, the annular luminous zone can be provided around the sound output element of the loudspeaker unit together with better acoustic performance and with the strength of the loudspeaker grille preserved.

A loudspeaker assembly for a vehicle according to the present invention can provide an annular luminous zone around a sound output element of a loudspeaker unit as observed from a cabin interior of the vehicle, together with an enhanced design quality that is achieved by reduction of the possible adverse effect from the geometry of a light guide component on the luminous pattern.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike or corresponding parts throughout the different figures, and:

FIG. 1 is a longitudinal cross-sectional view of a vehicle loudspeaker assembly in accordance with an embodiment of the present invention.

FIG. 2 is a perspective view of a light guide component of the vehicle loudspeaker assembly.

FIG. 3 is a front elevational view of the light guide component of the vehicle loudspeaker assembly.

FIG. 4 is a concept diagram that shows an example annular illumination from the light guide component of the vehicle loudspeaker assembly.

FIG. 5 is a radial cross-sectional view of the light guide component of the vehicle loudspeaker assembly.

FIG. 6 is a front elevational view of a loudspeaker grille of the vehicle loudspeaker assembly.

FIG. 7 is a perspective view of the loudspeaker grille of the vehicle loudspeaker assembly.

FIG. 8 is a longitudinal cross-sectional view of the vehicle loudspeaker assembly.

FIG. 9 is another front elevational view of the loudspeaker grille of the vehicle loudspeaker assembly.

FIG. 10 is a front elevational view of a door trim to which the vehicle loudspeaker assembly is fitted.

### DESCRIPTION OF EMBODIMENTS

What follows is the description of a preferred embodiment of the present invention made with reference to the drawings.

A loudspeaker assembly 1 for a vehicle according to the present invention is fitted to a door trim 100 that is an interior member mounted to a cabin interior side of a door of the vehicle as shown in FIG. 10 and outputs sound towards a cabin interior of the vehicle. FIG. 1 is a longitudinal cross-sectional view of the vehicle loudspeaker assembly 1. The vehicle loudspeaker assembly 1 includes a loudspeaker unit 2, a light guide component 3, and a loudspeaker grille 4. The left side, namely, the cabin interior side of the vehicle loudspeaker assembly 1 is protected by a porous or mesh-like plate member 5 (e.g., perforated metal) and a skin material 6 that covers the top surface of the plate member 5.

### Loudspeaker Unit

The loudspeaker unit 2 includes diaphragm 20 and a squawker 21 that causes the diaphragm 20 to vibrate in order to output sound waves. The diaphragm 20 functions as a sound output element. Preferably, the sound output element 20 is generally circular, or, otherwise, has an external contour line with a generally circular shape when viewed in a plan view in a direction in which the sound waves are output. The loudspeaker unit 2 includes a seal 8 that encircles the sound output element 20 to prevent sound from escaping. Examples of material of the seal 8 include a sponge.

### Light Guide Component

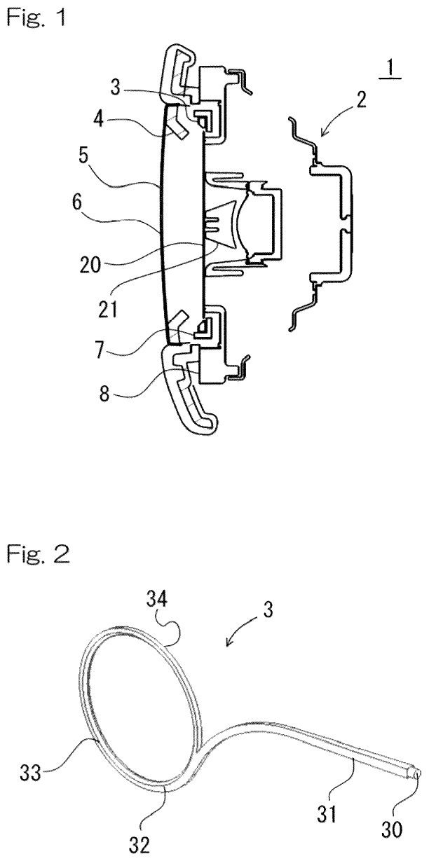

FIGS. 2 and 3 are a perspective view and a front elevational view of the light guide component 3, respectively. The light guide component 3 is formed of a bar-shaped element 31 and an annular geometrical element 32. A light source (not shown), such as an LED, is coupled to the tip 30 of the bar-shaped element 31 such that light from the light source is introduced into the light guide component 3.

The light guide component 3 is produced from light transmissive material in a die molding process or some other process that processes the light transmissive material into a desired form. Particular materials that can be used include polymer materials such as polycarbonates, acrylic polymers, and urethane polymers as well as inorganic materials such as glass.

Referring to FIG. 3, the light guide component 3 is arranged such that the annular geometrical element 32 of the light guide component 3 surrounds the sound output element 20 when viewed in a plan view in the axial direction of the sound output element 20 of the loudspeaker unit 2. The light guide component 3 in this arrangement has an interior side surface 33 that is a surface to be on the side of the cabin interior and an exterior side surface 34 that is a surface to be on the side of a cabin exterior of the vehicle, as shown in FIG. 2.

The light introduced into the light guide component 3 undergoes total internal reflection to propagate internally through the light guide component 3. Prescribed segments of the light guide component 3 are processed or treated in such a way to reflect the light propagating internally through the light guide component 3 to emit it to the outside of the light guide component 3, thereby producing an illumination from the light guide component 3.

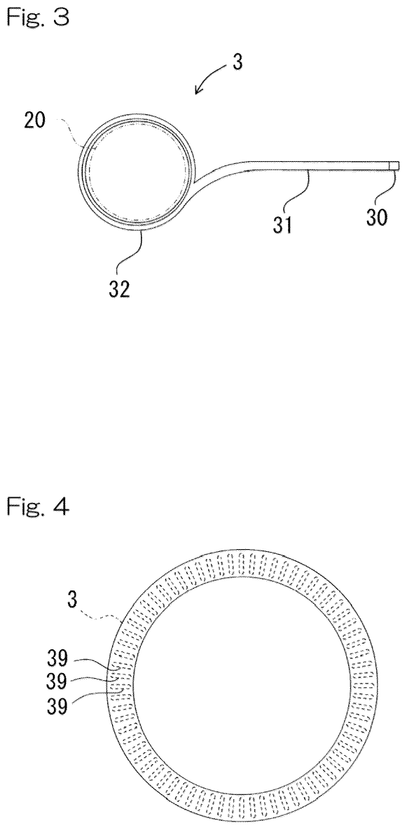

FIG. 4 is a concept diagram that shows an example illumination that is being produced from the light guide component 3. When recessed grooves 39 are formed in the exterior side surface 34 (FIG. 2) of the annular geometrical element 32 of the light guide component 3 so as to extend in the radial direction of the annular geometrical element 32, the grooves 39 create reflections of the light propagating internally through the light guide component 3 such that they are emitted to the outside of the light guide component 3. As a result, a luminous pattern of light emitted from the grooves 39 emerges when the light guide component 3 is observed in the direction of the interior side surface 33 (FIG. 2), i.e., from the cabin interior. By forming more than one such groove 39 adjacently and circumferentially at a prescribed interval in the exterior side surface 34 of the annular geometrical element 32 of the light guide component 3, a luminous pattern from the row-like arrangement of these grooves 39 manifests such that an annular illumination is observed as a whole, during the observation from the cabin interior.

A rectilinear recessed groove 39 (FIG. 4) such as the one described above is only one of the non-limiting examples of the form of a segment of the light guide component 3 to produce an illumination. The segment may have any form as long as it has irregularities with which to produce a reflection of the light propagating internally through the light guide component. The form of the irregularities made on the light guide component 3, including, for example, those made by fine dot processing or embossing, may be chosen according to the required design quality of the illumination, since their form determines the luminous pattern.

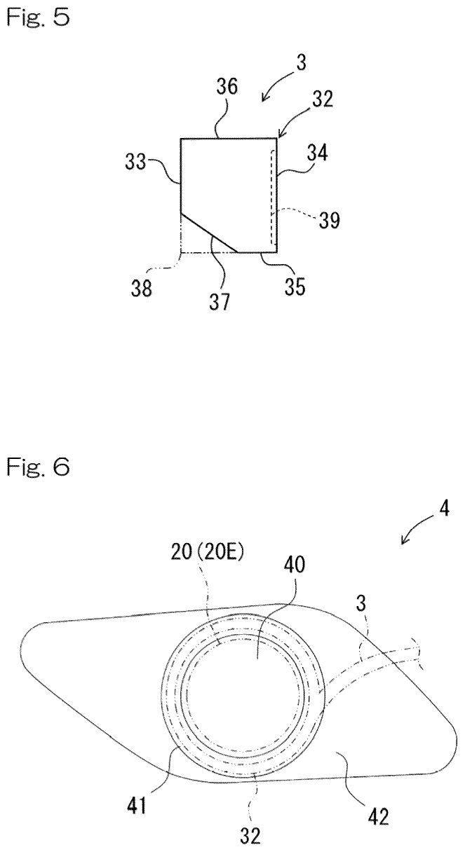

FIG. 5 is a radial cross-sectional view of the annular geometrical element 32 of the light guide component 3. The annular geometrical element 32 of the light guide component 3 in the instant embodiment has a skewed surface 37 in order to enhance the design quality of the luminous pattern from the light guide component 3.

If the annular geometrical element 32 of the light guide component 3 was cuboidally shaped to have the interior side surface 33 and the exterior side surface 34 with a radial cross section that is rectangular, the interior side surface 33 and the inner diameter surface 35 would extend perpendicular to form a right angle corner 38. In contrast, the annular geometrical element 32 of the light guide bar 3 according to the instant embodiment has, in addition to the interior side surface 33, the exterior side surface 34, and the inner diameter surface 35 and outer diameter surface 36 that are annularly shaped, a skewed surface 37 joining the interior side surface 33 and the inner diameter surface 35 along the entire circumference of these two surfaces. The interior side surface 33 and the inner diameter surface 35 are joined via the skewed surface 37 such that the annular geometrical element 32 has a radial cross section with a pentagonal shape having three substantially right angles.

The skewed surface 37 has a fixed inclination angle α (FIG. 8) to the axial direction of the annular geometrical element 32 or the central axis Ax of the annular geometrical element 32. Preferably, the inclination angle α is between 30 and 60 degrees. The skewed surface 37 could also be described as a lateral surface of a truncated cone with an increasing diameter towards the interior side surface 33.

The presence of the skewed surface 37 on the annular geometrical element 32 of the light guide component 3 can enhance the design quality of the annular illumination that can be observed from the cabin interior. Given the posture of a passenger and the height of the passenger's eyes, the passenger will observe the light guide component 3 producing the annular illumination in the vehicle loudspeaker assembly installed to the vehicle interior member, not by directly looking at the annular illumination in the axial direction of the same but by looking in a somewhat oblique direction. In this case, the light reflected from the exterior side surface 34 of the light guide component 3 and emitted to the outside of the light guide component 3 to be observed by the passenger not only includes light rays emitted through the interior side surface 33 but also includes light rays emitted through the inner diameter surface 35 of the annular geometrical element 32 of the light guide component 3.

As previously discussed, if the skewed surface 37 was not present on the annular geometrical element 32 of the light guide component 3, a right angle corner 38 would be formed at a point where the interior side surface 33 and the inner diameter surface 35 of the annular geometrical element intersect. According to this scenario, when the illumination produced by reflections from the exterior side surface 34 of the light guide component was observed from the cabin interior, the luminous pattern might look in a different way from the form processed in and/or on the exterior side surface 34 of the light guide component 3 due to undesired refraction experienced by light rays travelling in paths that go through the corner 38 between the interior side surface 33 and the inner diameter surface 35. For instance, if the grooves 39 were rectilinearly extending recesses formed in the exterior side surface 34 of the light guide component in the radial direction of the annular geometrical element 32, the luminous pattern corresponding to the rectilinear grooves 39 would be seen as containing a discontinuity in a part that corresponds to the corner 38.

In contrast, the light guide component 3 with the skewed surface 37 on the annular geometrical element 32 according to the instant embodiment allows the light reflected from the exterior side surface 34 of the light guide component 3 and emitted through the light guide component 3 to be observed from the cabin interior via either one of the interior side surface 33, the inner diameter surface 35, and the skewed surface 37. During this observation, the luminous pattern is less susceptible to undesired deformation caused by refraction of light at a corner of the light guide component 3, because the skewed surface 37 is provided in place of the right angle corner 38 between the interior side surface 33 and the inner diameter surface 35 such that the skewed surface 3 meets the line of sight of a passenger observing, from the cabin interior, the annular illumination from the light guide component 3. The corners with obtuse angles between the interior side surface 33 and the skewed surface 37 and between the skewed surface 37 and the inner diameter surface 35 are less likely than right angle corners to cause discontinuity, distortion, and/or other types of deformation in the shape of the luminous pattern observed from the cabin interior. Thus, an enhanced design quality of the luminous pattern can be achieved by the presence of the skewed surface 37 on the annular geometrical element 32 of the light guide component 3.

When assembled into the vehicle loudspeaker assembly 1 of FIG. 1, the light guide component 3 is held on a housing 7 that has a shape adapted to the shape of the light guide component 3. The housing 7 is disposed in such a way to hold the exterior side surface and the opposite lateral surfaces of the bar-shaped element 31 (FIG. 2) and to hold the exterior side surface 34 and the outer diameter surface 36 of the annular geometrical element 32 (FIG. 2). In this way, the bar-shaped element 31 of the light guide component 3 and the annular geometrical element 32 of the light guide component 3 that surrounds the sound output element 20 (FIG. 1) are prevented from directly contacting the seal 8 (FIG. 1) of the loudspeaker unit 2. Thus, the luminous pattern from the light guide component 3 can be kept in a desired shape and in a more stable way. Preferably, a clearance of at least 0.5 mm is provided between the light guide component 3 and the housing 7.

### Loudspeaker Grille

FIG. 6 is a front elevational view of the loudspeaker grille 4. The loudspeaker grille 4 is arranged so as to be situated on the side of the cabin interior relative to the loudspeaker unit 2 and the light guide component 3. The loudspeaker grille 4 has an opening 40 to let through the sound emitted from the loudspeaker unit 2 into the cabin interior. The opening 40 is a hole that is positioned in opposition to the output element 20 of the loudspeaker unit 2 of FIG. 1 and penetrates through the loudspeaker grille 4 between the cabin interior side surface and the cabin exterior side surface thereof.

The mesh-like or porous plate member 5 (e.g., perforated metal) and the skin material 6 are attached to the cabin interior side of the cabin interior side surface of the loudspeaker grille 4. The plate member 5 and the skin material 6 not only protect the sound output element 20 of the loudspeaker unit 2 but can also help provide an enhanced design quality.

The loudspeaker grille 4 has a transmissive section 41 (FIG. 6) that is transparent to light and a non-transmissive section 42 (FIG. 6) that is opaque to light. The loudspeaker grille 4 in the instant embodiment is molded from transparent resin and is surface-treated with a non-transmissive coating to form the non-transmissive section 42, leaving the remaining non-treated portions as the transmissive section 41. In an alternative embodiment, the loudspeaker grille 4 may be molded in a double molding process as an integrated article using a material transparent to light and a material opaque to light, such that different sections molded from the different materials respectively form the transmissive section and the non-transmissive section.

The transmissive section 41 of the loudspeaker grille 4 has a shape corresponding to the annular geometrical element 32 of the light guide component 3 arranged so as to be situated on the side of the cabin exterior relative to the loudspeaker grille 4. Thus, light emitted from the annular geometrical element 32 of the light guide component 3 can be transmitted through the transmissive section 41 to the cabin interior while light emitted from parts other than the annular geometrical element 32 is blocked by the non-transmissive section 42 from escaping into the cabin interior, such that that the annular illumination can be observed from the cabin interior.

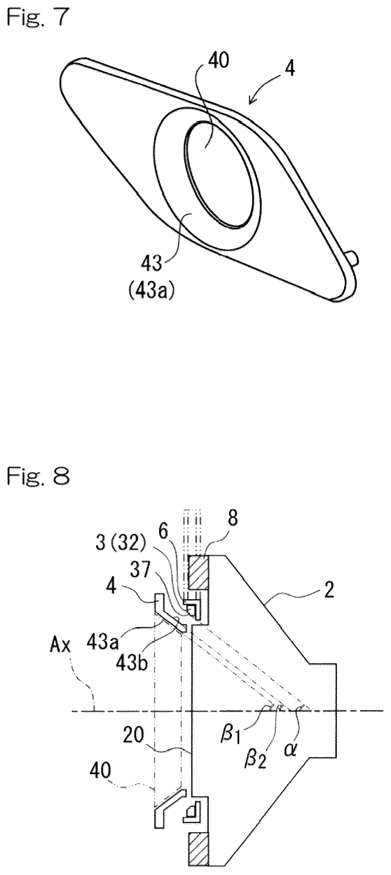

FIG. 7 is a perspective view of the loudspeaker grille 4. The loudspeaker grille 4 comprises a frustoconical tubular element 43 with an inner peripheral face 43a (FIG. 8) on the cabin interior surface and an outer peripheral face 43b (FIG. 8) on the cabin exterior surface. The frustoconical tubular element 43 has a frustoconical tubular body, i.e., a body with the internal material hollowed out to create a tubular configuration having a certain thickness from a frustoconical lateral surface with the opening 40 forming the hollow cavity with a frustoconical tubular form. The frustoconical tubular element 43 has an increasing diameter towards the cabin interior.

FIG. 8 is a cross-sectional view of the vehicle loudspeaker assembly 1 including the light guide component 3 and the loudspeaker grille 4. The annular geometrical element 32 of the light guide component 3 and the frustoconical tubular element 43 of the loudspeaker grille 4 are disposed coaxial in such a way that the inclination angle β1 of the inner peripheral face 43a and the inclination angle β2 of the outer peripheral face 43b of the frustoconical tubular element to the central axis Ax of the elements are substantially identical to the inclination angle α of the skewed surface 37 of the light guide component 3. Preferably, these inclination angles are at least 35 degrees. In this way, the annular illumination with an excellent design quality is readily viewed in more than one direction of observation.

As the inclination angle α of the skewed surface 37 of the light guide component 3 is substantially identical to the inclination angle β1 of the inner peripheral face 43a and the inclination angle β2 of the outer peripheral face 43b of the frustoconical tubular element 43 of the loudspeaker grille 4, light emitted through the skewed surface 37 of the light guide component can form an incident angle of zero degree or substantially zero degree (and thus can be in a state close to normal incidence) relative to the inner peripheral face 43a and the outer peripheral face 43b of the frustoconical tubular element 43 of the loudspeaker grille 4 such that the emitted light does not experience undesired refraction. Hence, the luminous pattern that constitutes the annular illumination observed from the cabin interior does not suffer from discontinuity, distortion, and/or other problems.

Accordingly, even when the annulus illumination from the light guide component 3 is observed from the cabin interior through the transmissive section 41 (FIG. 6) of the loudspeaker grille 4, the provision of the skewed surface 37 on the light guide component 3 can assist the luminous pattern from the light guide component 3 in preserving an enhanced design quality.

Further, the opening 40 that lets through the sound output from the sound output element 20 of the loudspeaker unit 2 is shaped to have an increasing diameter towards the cabin interior. Thus, the sound output element 20 can generate sound in such a way that the sound spreads into the cabin interior, thereby providing enhanced acoustic performance.

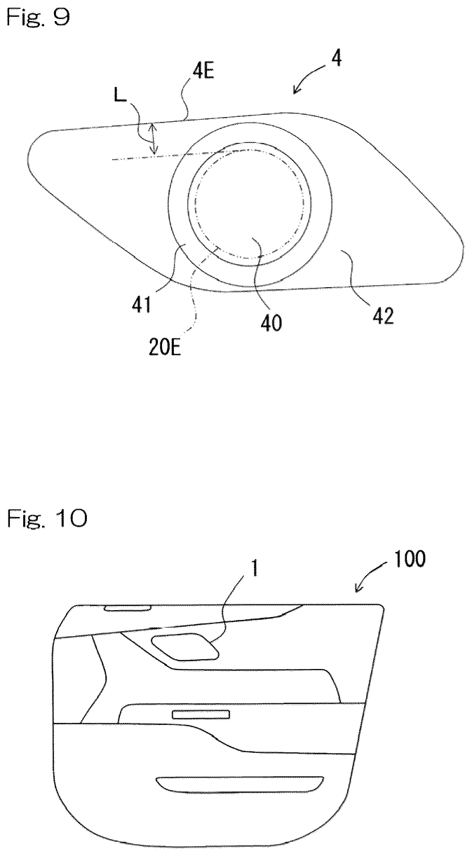

FIG. 9 is another front elevational view of the loudspeaker grille 4. As described above, the loudspeaker grille 4 has the transmissive section 41 and the non-transmissive section 42 to allow the annular illumination to be observed from the cabin interior. In addition, the presence of the transmissive section 41 helps give the loudspeaker grille 4 a greater strength and results in an enhanced design quality of the loudspeaker assembly as a whole, as will be further discussed below.

If the loudspeaker grille 4 did not have the transmissive section 41, the opening 40 of the loudspeaker grille 4 would need to have a diameter that exceeds both the external contour line 20E of the sound output element 20 of the loudspeaker unit 2 and the outer diameter of the annular geometrical element 3 of the light guide component 3, to allow the annular illumination from the light guide component 3 to be observed from the cabin interior. Then, however, there may not be a reliable amount of distance between the opening 40 and the outer periphery 4E of the loudspeaker grille 4 in the sense that some parts of the loudspeaker grille might lack in thickness with a correspondingly inadequate strength.

Yet, if more thickness was added to the underside of the opening 40 of the loudspeaker grille 4 with no change in the shape of the outer periphery 4E of the loudspeaker grille 4 to give the loudspeaker grille 4 a greater strength, the geometry of the opening 40 of the loudspeaker grille 4 could get in the way of observing the annular geometrical element 32 of the light guide component 3 from the cabin interior in the sense that the annular geometrical element 32 of the light guide component 3 is partially concealed by the loudspeaker grille 4 that acts as a light blocking element, thereby hindering the creation of the annular illumination.

Alternatively, if more thickness was added in the direction of the outer periphery of the loudspeaker grille 4 with no change in the circular form of the opening 40 of the loudspeaker grille 4 as viewed in a plan view from the cabin interior to give a greater strength, the external dimension of the loudspeaker grille 4 might become oversized in such a way that results in a design quality that is compromised in terms of, for example, the position and size balance of the annular illumination within the space occupied by the loudspeaker grille 4 as observed from the cabin interior. This is unfavorable as, in addition, there is a risk that the loudspeaker assembly 4 might not meet the dimensional criteria required for being fitted to the door trim or some other vehicle interior member.

These issues are resolved by the transmissive section 41 that the loudspeaker grille 4 has and is transparent to light. The transparency of the transmissive section 41 to light emitted from the light guide component 3 (FIG. 6) makes it possible for the annular illumination with an excellent design quality to be created despite the fact that the diameter of the opening 40 is smaller than the diameter of the annular geometrical element 32 of the light guide component 3. Such a relatively small diameter of the opening 40 can also ensure that there is an adequate distance from the opening 40 to the external contour line 4E of the outer circumference of the loudspeaker grille 4, thereby making it possible for the loudspeaker grille 4 to attain both a greater strength and an enhanced design quality. Here, it is preferred that the smallest distance L between the external contour line 20E of the sound output element 20 located radially inwards of the opening 40 and the external contour line 4E of the outer circumference of the loudspeaker grille 4 is at least 9.5 mm when the sound output element 20 is frontally viewed in a plan view. In this case, it is preferred that the axial width of the loudspeaker grille 4, including the frustoconical tubular element 43, from the cabin interior side surface to the cabin exterior side surface thereof is between 10 mm and 15 mm, inclusive.

The present disclosure is not limited to the foregoing embodiments, and various additions, changes, or omissions can be made therein without departing from the principle of the present disclosure.

### REFERENCE NUMERALS

1 . . . loudspeaker assembly
2 . . . loudspeaker unit
20 . . . sound output element
21 . . . squawker
3 . . . light guide component
30 . . . light entry port
31 . . . bar-shaped element
32 . . . annular geometrical element
33 . . . interior side surface
34 . . . exterior side surface
35 . . . inner diameter surface
36 . . . outer diameter surface
37 . . . skewed surface
4 . . . loudspeaker grille
40 . . . opening
41 . . . transmissive section
42 . . . non-transmissive section
43 . . . frustoconical tubular element
43a . . . inner peripheral face of frustoconical tubular element
43b . . . outer peripheral face of frustoconical tubular element

What is claimed is:

1. A loudspeaker assembly for a vehicle, the loudspeaker assembly comprising:
a loudspeaker unit including a sound output element;
a light guide component disposed around the sound output element; and
a loudspeaker grille disposed so as to be situated on the side of a cabin interior of the vehicle relative to the loudspeaker unit and the light guide component, at least a part of the loudspeaker grille being transparent to light, and the light guide component being configured to be illuminated in such a way to create an annular luminous zone on a cabin interior side of the loudspeaker grille.

2. The loudspeaker assembly as claimed in claim 1, wherein the loudspeaker grille has a transmissive section that is transparent to light emitted from the light guide component and a non-transmissive section that is opaque to light.

3. The loudspeaker assembly as claimed in claim 1, wherein the light guide component comprises an annular geometrical element having an outer diameter surface, an inner diameter surface, an interior side surface to be on the side of the cabin interior, and an exterior side surface to be on the side of a cabin exterior of the vehicle, the annular geometrical element further has a skewed surface which is at an inclination to an axial direction of the annular geometrical element and via which the interior side surface and the inner diameter surface are joined, and the annular geometrical element has a radial cross section with a pentagonal shape having three substantially right angles.

4. The loudspeaker assembly as claimed in claim 3, wherein the loudspeaker grille comprises a frustoconical tubular element with a diameter that increases towards the cabin interior, the frustoconical tubular element is disposed coaxial with the annular geometrical element of the light guide component, and the frustoconical tubular element has inner and outer peripheral faces with respective inclination angles that are substantially identical to an inclination angle of the skewed surface of the light guide component.

5. The loudspeaker assembly as claimed in claim 1, wherein the smallest distance from an external contour line of the sound output element to an external contour line of an outer periphery of the loudspeaker grille is at least 9.5 mm when the sound output element is frontally viewed in a plan view.
